(19) United States
(12) Patent Application Publication
(10) Pub. No.: US 2006/0050516 A1
(43) Pub. Date: Mar. 9, 2006

(54) Reflector

(76) Inventor: Junichi Saitoh, Yamagata-city (JP)

Correspondence Address: 3M INNOVATIVE PROPERTIES COMPANY, PO BOX 33427, ST. PAUL, MN, 55133-3427, US

(21) Appl. No.: 10/527,305

(22) PCT Filed: Aug. 21, 2003
(86) PCT No.: PCT/US03/26011

§ 371 Date: Mar. 9, 2005

(30) Foreign Application Priority Data
Sep. 24, 2002 (JP) 2002-277175

(51) Int. Cl. F21V 7/00

(52) U.S. Cl. 362/341

(57) ABSTRACT

There is provided a reflector capable of reflecting light at a wide angle of incidence, for which the manufacturing time can be easily shortened even if a comparatively hard reflection sheet is used and of which the reflection sheet is effectively prevented from being cracked or peeled from the supporting body. A reflector comprising: a supporting body (1) which has a base (11) and a plurality of projections (12) having a sloping surface (120), and a reflection sheet (2) disposed on the surface of the base and sloping sections (120) of the projections (12); wherein the length of the surface (10) between the projections in the direction of width is larger than the length of the projection in the direction of width, and the surface of the base (1) has at least one peripheral surface (101b) of each projection (12) extending along the periphery of the direction of width of the projections (12) at each of the projections (12); and the reflection sheet (2) further includes a peripheral section (22b) disposed on the peripheral surface (101b) of each projection, and the sloping section (21) of the reflection sheet (2) is linked with one (20a) of the two adjacent sections (20a, 20b) between the projections (12) and separated from the other section (20b) and the peripheral section (22b) of the projection.

### BACKGROUND

The present invention relates to improvement of a reflector comprising a supporting body having a plurality of projections on the surface and a reflection sheet adhering to the surface of the supporting body. The reflector of the present invention can reflect light at a comparatively wide angle of incidence and can be used as a reflector of light at a wide angle of incidence to be installed in guardrails, curved locations, walls along a road, road surface, and the like. Such a reflector is particularly useful as a gaze direction mark or a component thereof, for example.

Since reflectors (reflection materials, reflection plates, etc.) must be very visible to observers (drivers, etc.) driving vehicles at night, a reflection sheet is secured to the surface to increase visibility. A prism-type reflection sheet is given as an example of the reflection sheet. The prism-type reflection sheet is a retroreflective sheet, usually containing a prism sheet in which a plurality of cube corner prisms are provided.

To increase characteristics at a wide angle of incidence a reflector is usually designed to have a supporting body, which has a base and a plurality of projections provided at regular intervals and bonded to the surface of the base in the longitudinal direction of the base, and a reflection sheet adhering to the supporting body. The projections are provided with a sloping surface sloping with respect to the surface of the base. The reflection sheet includes sections between the projections adhering to the surface between the projections on the base and sloping sections disposed on the sloping surface of the projections. Incident light irradiating the reflection surface (the surface of the reflection sheet disposed on the supporting body) at a comparatively small angle of incidence (coming from the direction close to the normal line of the refection surface) is effectively reflected in the sections between the projections. On the other hand, incident light irradiating the reflection surface at a comparatively large angle of incidence (coming from the direction nearer to the horizontal of the refection surface) is effectively reflected in the sloping sections. In this manner, this type of reflector exhibits excellent reflection characteristics (reflection characteristics at a wide angle of incidence) for incident light at angles in a wide range of incidence.

There are disclosed reflectors, as conventional reflectors, consisting of almost flat surfaces covered with a retroreflective sheet and reflection surfaces having a plurality of projections, which are disposed side by side with the almost flat surfaces interposes between them, and covered with a reflection sheet (e.g. patent literatures 1 and 2).

This type of reflector is formed by providing a supporting body and a laminated body containing a reflection sheet adhering to the surface of the supporting body, and embossing the laminated body. A plurality of projections, each having a sloping surface and a reflection sheet disposed thereon, can be formed by the embossing process. It is possible to produce such a reflector by previously forming a base and a supporting body with a plurality of projections integrally formed thereon, and then disposing a reflection sheet on the surfaces between the projections and along the concave-convex surfaces of the projections. The supporting body is formed by a forming method such as injection molding or the like and is usually provided with a base made from a resin and a plurality of projections integrally combined with the base.

The patent literature 2 proposes a method of preventing peeling of the reflection sheet from the supporting body by folding the periphery of the supporting body in at least part of the periphery of the reflection sheet adhering to the supporting body so that the periphery of the supporting body may enclose the periphery of the reflection sheet.

In the reflector with this structure, sections between the projections of the reflection sheet adhering to the surface of the supporting body between the projections and sloping sections of the reflection sheet disposed on the sloping surfaces of the projections are alternately and continuously formed. Specifically, a sloping section of the reflection sheet is linked to both of the sections between the projections located in juxtaposition with the sloping section.

### Patent Literature 1

### Japanese Patent Application Laid-Open H10-333616

### Patent Literature 2

### Japanese Patent Application Laid-Open 2001-3324

### SUMMARY

However, conventional reflectors at a wide angle of incidence have the following problems which are still to be improved. Some reflection sheets are comparatively hard and extendable only with difficulty. For example, the above-described prism-type reflection sheet is included in this type of reflection sheet. This is because the prism-type reflection sheet contains a prism sheet made from a comparatively hard resin such as acrylic resin and polycarbonate resin. In addition to the prism-type reflection sheet, there are sheets containing a protective film made from a comparatively hard resin. Such a protective film is provided to protect the soft surface of a reflection sheet from being damaged by stones and the like in the case of vehicle collisions or thrown up by tires, impairing reflection performance of the sheet.

However, when a reflector with a plurality of projections is produced using a reflection sheet made from a comparatively hard resin, the reflection sheet may be cracked, or peeled from the supporting body for the following reasons. when performing an embossing process on a laminated body including a reflection sheet adhering to the surface of a supporting body or when causing a reflection sheet to adhere along concave and convex sections on the surface of a supporting body provided with a plurality of projections, the reflection sheet is deformed in an attempt to make it conform to the concave and convex sections including the projections. In this instance, elongation stress is generated in the sloping section of the reflection sheet in the direction toward the two sections between the projections adjacent to each other (direction from the side of the apex of the convex section to the side of the concave section).

When an embossing process is performed, the reflection sheet may be cracked or peeled if the sheet cannot be elongated to sufficiently absorb the elongation stress. Therefore, the embossing process must be carefully performed so that the elongation stress can be absorbed by, for example, curing the material with heat during the embossing process or performing a multistage press. Otherwise, some additional procedure such as folding the periphery of the supporting body will be needed. This is disadvantageous for reduction of processing time. If the elongation stress cannot be sufficiently absorbed when the reflection sheet is arranged along irregularities on the surface of a supporting body, the arrangement may fail or, even if the reflection sheet adheres, the sheet may be peeled from the supporting body during use.

Therefore, an object of the present invention is to provide a reflector capable of reflecting light at a wide angle of incidence, for which the manufacturing time can be easily shortened even if a comparatively hard reflection sheet which can be elongated only with difficulty is used and of which the reflection sheet is effectively prevented from being cracked or peeled from the supporting body.

### BRIEF DESCRIPTION OF THE DRAWINGS

FIG. 1 is a side view showing a mode for carrying out the reflector of the present invention.

FIG. 2 is a plan view of a supporting body used in the reflector in FIG. 1 viewed from above.

FIG. 3 is a side view of the supporting body used in the reflector in FIG. 1.

FIG. 4 is a plan view of the reflection sheet used in the reflector in FIG. 1 viewed from above.

### DETAILED DESCRIPTION

According to the present invention, there is provided a reflector comprising: a supporting body which has a base having a surface extending in a longitudinal direction and a plurality of projections having a sloping surface sloping with respect to the surface of the base and being provided in the longitudinal direction of the surface of the base at regular intervals and bonded to the surface of the base, and a reflection sheet which has sections between the projections disposed between projections on the surface of the base and sloping sections adhering to the sloping surface of the projections;
wherein the length of the surface between the projections in the direction perpendicular to the longitudinal direction (direction of width) of the surface of the base is larger than the length of the projection in the same direction (direction of width), and the surface of the base has at least one peripheral surface of each projection extending along the periphery of the latitudinal direction of the projections at each of the projections so as to link the adjacent surfaces between projections;
and the reflection sheet further includes peripheral sections of each projection disposed on the peripheral surface of the projection to link the adjacent sections between the projections, and the sloping section of the reflection sheet is linked with one of the two adjacent sections between the projections and separated from the other section and the peripheral section of the projection.

In the reflector of the present invention, the sloping section of the reflection sheet is linked with one of the two sections between the projections located in juxtaposition and separated from (not linked with) the other section and the peripheral section of the projection. Therefore, the reflection sheet is effectively prevented from being cracked or peeled from the supporting body even if a comparatively hard reflection sheet which can be elongated only with difficulty is used. This is owing to the structure of the reflector, in which the sloping section of the reflection sheet are separated from the sections between the projections of the reflection sheet, so that deformation stress such as an elongation stress of the reflection sheet can be effectively adsorbed. This structure can easily reduce the manufacturing time without requiring additional procedures detrimental to shortening of manufacturing time as in the case of conventional manufacturing processes.

In this structure, the length of the surface (region) between the projections in the latitudinal direction perpendicular to the longitudinal direction (direction of width) of the surface of the base must be larger than the length in the same direction (direction of width) of the projection parallel to the latitudinal direction of the surface between the projections. In this manner, the surface of the base is provided with at least one peripheral surface of the projection extending along the periphery of the latitudinal direction of each of the projections (longitudinal direction on the surface of the base) so that the surfaces between the projections adjacent to each other are linked together. Notches are provided in the reflection sheet so that the sloping sections of the reflection sheet can be separated from the sections between the projections of the reflection sheet. The peripheral sections of the projections linking the sections between the projections located in juxtaposition are also provided in the reflection sheet.

It is sufficient that the peripheral section of each projection of the reflection sheet be provided in at least one periphery of the projection in the latitudinal direction. For example, when one periphery of a projection in the latitudinal direction coincides with one periphery of the base in the latitudinal direction, only one peripheral section of the projection is provided on the other periphery of the projection in the latitudinal direction. In this instance, the sections between the projections of the reflection sheet located in juxtaposition may be linked by one peripheral section of the projection. On the other hand, when both ends of the projections in the latitudinal direction are apart from both peripheries of the base in the latitudinal direction, two peripheral sections for each projection are provided along the two peripheries in the latitudinal direction of the projections. In this instance, the reflection sheet may be provided with two peripheral sections of the projection disposed on the two peripheral surfaces of each projection.

### Mode for Carrying Out the Invention

A mode for carrying out the present invention is hereinbelow described specifically with referring to drawings. However, the present invention is by no means limited to the following mode for carrying out the invention, and it should be understood that modifications, improvements, etc., of the design may be accepted suitably within a range without deviation from the point of the present invention on the basis of knowledge of a person of ordinary skill.

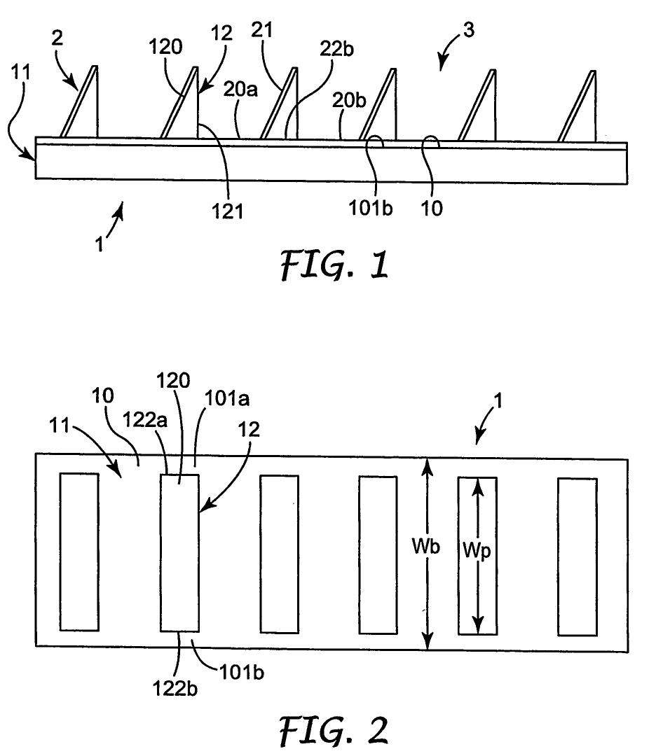

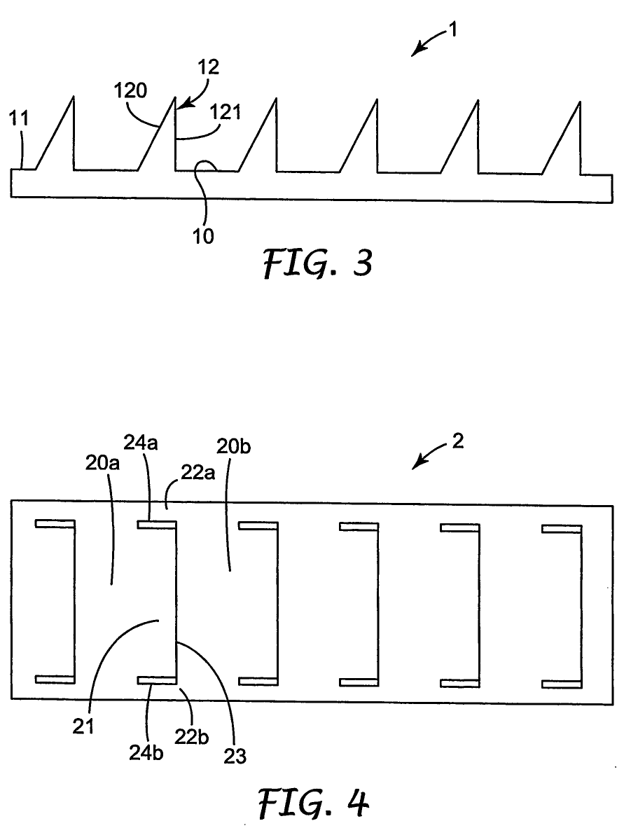

FIG. 1 is a side view of a reflector (3). FIG. 2 is a plan view of a supporting body (1) used in the reflector in FIG. 1 viewed from above. FIG. 3 is a side view of the supporting body (1) used in the reflector in FIG. 1. FIG. 4 is a plan view of a reflection sheet (2) used in the reflector in FIG. 1 viewed from above.

The reflector (3) shown in FIG. 1 has a structure comprising: the supporting body (1), which has a base (11) having a surface extending in a longitudinal direction and a plurality of projections (12) arranged at regular interval and bonded to the surface of the base (11) in the longitudinal direction of the base (11), and the reflection sheet (2) disposed the supporting body (1).

The projections (12) have a sloping surface (120) sloping with respect to the surface of the base (11). The reflection sheet (2) has sections (20a, 20b) between the projections arranged on the surface (10) located among a plurality of projections on the base (11) and sloping sections (21) arranged on the sloping surface (120) of the projections. The length (Wb) of the surface between the projections (10) in the latitudinal direction perpendicular to the longitudinal direction of the base (length of width of the surface between the projections) is larger than the width (Wp) of the projection (12) in the same direction (direction parallel to the latitudinal direction of the surface between projections (10)), and the surface of the base has two peripheral surfaces (101a, 101b) for each projection extending along both peripheries (122a, 122b) in the latitudinal direction of the projection (12) so as to link the surfaces between the projections mutually adjacent to each other.

The reflection sheet (2) further includes two peripheral sections (22a, 22b) of each projection disposed on peripheral surfaces (101a, 10b) of each projection linking the sections adjacent to each other between the projections (20a, 20b). The sloping section (21) of the reflection sheet is linked with one of the juxtaposing sections (20a), but separated from the other juxtaposing section (20b) and the projecting peripheral sections (22a, 22b). To dispose the reflection sheet on the supporting body, the reflection sheet is usually disposed by means of an adhesive layer (not shown in the drawings) provided between them.

The sloping surface (120) slopes with respect to the surface (10) between the projections on the base, and the angle made by the sloping surface (120) and the surface (10) between the projections is obtuse (larger than 90°). The angle of gradient of the sloping surface is usually 100-170°, and preferably 110-160°. It is sufficient for the projection (12) to have at least one sloping surface. The shape of the projection (12) is not limited to the triangular prism shown in the figures. The shape may be a multiangular prism such as, for example, a quadangular prism, pentangular prism, and the like. The sloping surface (120) may have any shape other than the plane shown in the figures inasmuch as light coming in at a comparatively high angle of incidence can be effectively reflected. A curved surface includes a mildly curved concave surface, a mildly curved convex surface, and a bending surface having two or more slopes with different angles (a surface of which the cross-section is a polygonal line.)

The reflector of the present invention is preferably produced by respectively providing the supporting body (1) shown in FIG. 2 and FIG. 3 and the reflection sheet (2) having notches (23) as shown in FIG. 4, and by bonding (arranging) them. This method of preparation has an advantage of being a simple manufacturing process and ensures reduction of manufacturing time. The reflection sheet is bonded to (disposed on) the supporting body after providing the notches (23) in the reflection sheet (2) so as to outline the plane configuration of the sloping section (21) as shown in FIG. 4. That is, it is preferably formed by disposing the reflection sheet (2) on the sloping surface (120) of the projections (12) so that the sloping section (21) of the reflection sheet (2) is separated and projected from the other section at notches (23) provided to outline the plane configuration of the sloping section (21) of the reflection sheet (2). In this manner, the sloping section (21) of the reflection sheet may be cut from the other section (20b) between the sections between the projections adjacent to each other and the projecting peripheral sections (22a, 22b). These sections are easily separated after adhering to (being disposed on) the supporting body. The sloping section (21) is preferably designed to have almost the same plane configuration as the plane configuration of the sloping surface (120) of the projection. This is advantageous for increasing the sloping reflection area as large as possible, thereby improving the reflection characteristics of incident light at angles with a wide range.

The sloping section (21) is preferably designed to have a smaller area than the area of the sloping surface (120) of the projection so that the sloping surface (120) of the projection is provided with a space not covered with the sloping part (120) of the reflection sheet. The above-described method of fabricating the reflector by bonding (disposing) the reflection sheet (2) with notches (23) to (on) the supporting body (1) is preferable. In this instance, positioning of the projection (12) of the supporting body and the notch (23) of the reflection sheet is important. However, increasing the accuracy of positioning is difficult in many cases. To this end, it is preferable to provide openings (24a, 24b) around the sloping section (21) to function as the above space. This construction simplifies the manufacturing process and is particularly advantageous in view of reduced manufacturing time. In the case of the structure shown in the figure, the openings are provided only between the projecting peripheral sections (22a, 22b) and the sloping section (21). Such openings may also be provided only between the section (20b) between the projections and the sloping section (21) or may be provided in both of the sections. Although the width of the openings (the distance between the sloping section and the peripheral section of a projection or the like to be separated therefrom) differs according to the size of the sloping area of the projection, such a width is usually in the range of 0.1-5 mm.

In the case of the supporting body (1), as shown in FIG. 1, the surface of the base (11) has two peripheral surfaces (101a, 101b) for each projection extending along both peripheries (122a, 122b) in the latitudinal direction of the projection (12). To allow such a configuration, the notch (23) of the reflection sheet (2) shown in FIG. 4 has a shape similar to the symbol “]”. In this manner, the reflection sheet may be provided with two projecting peripheral sections (22a, 22b) adhering to the two projecting peripheral surfaces. The shape of the notch (23) is usually determined according to the shape of the sloping surface of the projection of the supporting body. Therefore, the shape of the notch (23) is not necessarily similar to the symbol “]”, but may be similar to the character “v” or “u”. However, the notch in the shape of the symbol “]” is particularly preferably formed because the sloping section in the shape close to a rectangle is advantageous to increase the area of the sloping section as large as possible, thereby increasing the reflection performance.

The periphery of the sloping section of the reflection sheet adhering to the sloping surface of the projections is preferably sealed. The reason is that the sealed periphery is advantageous for preventing peel of the reflection sheet or invasion of foreign matters such as water into the reflection sheet. The periphery can be sealed by coating a sealing agent or an adhesive or by adhering a sealing tape to the periphery. When the supporting body is made from a thermoplastic resin or a rubbery resin, the reflection sheet may be bonded to the supporting body by fusion with heat or ultrasonic wave. The seal is preferably attached to the periphery of the reflection sheet, excluding the sloping section of the reflection sheet such as the peripheral section of each projection.

The projection (12), as shown in FIG. 3, has a side (121) standing vis-à-vis the sloping surface (120). The side (121) is standing almost perpendicularly to the surface (10) between the projections of the base (11). However, the side (121) may lie at a certain angle with respect to the surface between the projections (10). In the reflector (3) having a mode for carrying out the invention shown in FIG. 1, no reflection sheet is disposed on the side (121). However, the side may have a reflection sheet disposed thereon and may be used as a reflecting surface. In such a case, a reflection sheet different from the reflection sheet (2) disposed on the sloping surface (120) may be adhering to the side (121). It is also possible to dispose a part of reflection sheet (2) on the side (121). When a part of the reflection sheet (2) is disposed on the side (121), it is possible for the reflection sheet (2) to be disposed on the supporting body after providing the notches (23) in the reflection sheet (2) so as to outline the plane configuration of said part to be attached to the side (121) in the same way as in the case of the sloping section (21).

The present invention is hereinbelow described more specifically regarding every constituent.

(Supporting Body)

The reflector of the present invention is useful as a gaze direction mark (also called a delineator) attached to the surface of an object such as a cube stone, guardrail, and tunnel wall, and the like. When the reflector is used on the roadside, the reflector is preferably designed to be protected from being damaged by vehicle collisions, by stones and the like thrown up by tires, by being contacted by vehicles, and the like. Therefore, it is preferable to fabricate the supporting body (1) from an elastically deformable resin.

The resin forming the supporting body (1) is preferably a rubbery resin. The rubbery resin does not disturb running of vehicles when the reflector (3) is damaged and its structural parts such as a supporting body (1) and the like drop on the road. In addition, the rubbery resin is particularly advantageous due to its capability of effectively absorbing an impact on the reflection sheet (2) and preventing the reflection sheet (2) from being cracked and broken.

A rubbery resin is usually a rubber selected from the group consisting of ethylene propylene rubber (EPDM, etc.), silicone rubber, butadiene rubber, chloroprene rubber, fluororubber, acrylic rubber, styrene-butadiene rubber, and acrylonitrile-butadiene rubber, or a mixture of two or more of these rubbers. Of these, ethylene propylene rubber is particularly preferable in view of its capability of effectively protecting the supporting body itself from being damaged due to its high flexibility and impact resistance. A vulcanized rubbery resin is also preferable.

The supporting body (1) is integrally formed from a rubbery resin or the like. The supporting body (1) is integrally combined with a base (11) and projections (12), preferably. The integrally combined structure is advantageous because the supporting body (1) with such a structure will not be easily destroyed. Fillers such as carbon black are preferably added to the resin for improving durability and weather resistance.

The base (11) for the supporting body (1) is usually a plate having a prescribed thickness. However, the base may have any other shape to the extent that the effect of the present invention is not adversely affected. When the base (11) is a plate, its thickness is usually 0.5-10 mm, and preferably 1-7 mm. There are also no specific limitations to other dimensions of the supporting body to the extent that the effect of the present invention is not adversely affected. The projection (12) has usually a height (the distance between the tip of the sloping surface (120) and the base (11)) of 5-15 mm, a width (Wp) in the latitudinal direction of 20-100 mm, and a length in the longitudinal direction perpendicular to the latitudinal direction of 10-20 mm. The distance kept between the projections, in terms of the distance between the tips of the sloping surfaces located in juxtaposition, is usually 30-70 mm when a plurality of projections (12) are arranged at regular intervals in a the longitudinal direction of the base surface.

(Reflection Sheet)

As the reflection sheet (2), a capsule-type retroreflective sheet can be usually used. Such a retroreflective sheet usually includes a prism sheet which contains small prisms such as (1) transparent bead layers and (2) cube corner prisms. As the retroreflective sheet of the type (2) above, the previously described cube corner prism-type retroreflective sheet can be given as an example.

The prism sheet is a polymer sheet of which one of the main surfaces (prism surface) has a plurality of small prisms regularly arranged and the other main surface is an almost flat non-prism surface. As specific examples of commercially available products of such a prism sheet, “Diamond Grade 3970 series” and “Diamond Grade 981 series” (manufactured by 3M Co.), “Crystal Grade series” (manufactured by Nippon Carbide Industries Co., Inc.), and the like can be given. The thickness of the reflection sheet is usually 80-1,000 mm.

The reflection sheet (2) may be light-transmissive as a whole. In this instance, if the supporting body (1) is also light-transmissive, sunlight can be transmitted and visualized at dusk and dawn. To the extent that the effect of the present invention is not impaired, the back of the reflection sheet such as the surface of the supporting body may be provided with a self-light-emitting device such as an EL device, LED, storage light-emitting device, and the like so that the reflection surface may emit light from the self-light-emitting device.

(Method of Fabricating the Reflector)

The reflector (3) of a mode for carrying out the invention can be fabricated in the same manner as conventional reflectors except for the requirement for providing specified notches in the reflection sheet (2).

Usually, a resin is formed to have a prescribed shape and dimensions for the supporting body (1). The notches for the reflection sheet (2) are produced by, for example, presswork, laser cutting, or the like. Computer control is preferably employed for positioning in arranging notches.

There are no limitations to the types of adhesive used for attaching the reflection sheet (2) to the supporting body (1) inasmuch as the effect of the present invention is not adversely affected. For example, a pressure sensitive adhesive, thermosensitive adhesive, solvent-type adhesive, and the like may be used. The adhesive usually contains an adhesive polymer. As the adhesive polymer, acrylic polymer, nitrile-butadiene copolymer (NBR, etc.), styrene-butadiene copolymer (SBR, etc.), polyurethane, silicon-containing polymer, and the like can be used. The thickness of the adhesive layer is usually 10-200 mm, and preferably 20-100 mm. The coating surface of the supporting body (1) may be treated with a primer. It is possible to attach the reflection sheet (2) to the supporting body (1) by fusing or melting without using an adhesive.

In a preferable method of fabricating the reflector (3) of a mode for carrying out the present invention, one end of the supporting body (1) in the longitudinal direction is caused to come to one end of the reflection sheet (2) with notches in the longitudinal direction, and the reflection sheet (2) is caused to adhere to the supporting body (1) sequentially from that one end in the longitudinal direction of the reflection sheet (2) to the other end. This method of fabrication particularly makes positioning of the projections (12) on the supporting body (1) and the notches in the reflection sheet (2) easier and shortens the fabrication time.

### EXAMPLES

### Example 1

In Example 1, a reflector with the structure shown in FIG. 1 was prepared in the following manner.

A supporting body was prepared using a peroxide vulcanized rubber as a resin for the supporting body. The surface of the supporting body was treated with a primer (“C-100” manufactured by 3M Co.). Then, a retroreflective sheet (“Diamond Grade 3970” manufactured by 3M Co.) with notches was caused to adhere to the supporting body using an acrylic pressure-sensitive adhesive.

Dimensions of the supporting body were as follows: the thickness of the supporting body in the substrate plate section: 5 mm, the height of the projection: 10 mm, the width in the latitudinal direction of the projection (Wp): 60 mm, the length in the longitudinal direction of the projection perpendicular to the width in the longitudinal direction of the projection: 15 mm, the distance between the projections: 57 mm.

### Example 2

A reflector of Example 2 was prepared in the same manner as in Example 1 except for using an acrylic resin (“Acrypet IR-H50”, impact resistant grade, manufactured by Mitsubishi Rayon Co., Ltd.) as the resin for the supporting body.

### Comparative Example 1

Comparative Example 1 is an example where the reflector was prepared in accordance with Comparative Example 1 disclosed in the aforementioned patent literature (Japanese Patent Application Laid-open No. 2001-3324) by forming projections to which a reflection sheet without notches adheres.

The reflector of Comparative Example 1 was fabricated by forming a laminated body by causing the reflection sheet to adhere to an aluminum supporting body (thickness: 0.8 mm) in a sheet-like shape and subjecting the laminated body to an embossing process. The embossing process was carried out under an embossing pressure of about 70 kg/mm² using a tool prepared by combining the first tool having projections and the second tool provided with depressed sections capable of receiving the projections of the first tool. The embossing process was carried out by pressing projections against the back face side (face opposite to a face where a reflection sheet is arranged) of the supporting body. The protruded section (section of a projection) formed by the embossing process had a height of 2.5 mm and a width of 25 mm, with a pitch between the protruded sections (sections of projections) of 15 mm.

### Comparative Example 2

Comparative Example 2 is also an example of fabricating a reflector by forming projections to which a reflection sheet without notches adheres. The reflector of Comparative Example 2 was fabricated in the same manner as in Comparative Example 1, except for using a plate formed from the same acrylic resin as used in Example 2 as the supporting body and softening the laminated body with heating prior to the embossing process.

The reflectors fabricated in the above Examples and Comparative Examples were evaluated by the following methods to confirm that the reflectors of the present invention are excellent as compared with conventional reflectors. The evaluation results are shown in Table 1.

1) Reflection performance: Brightness of light at a high angle of incidence was compared by visual observation from a viewer's peep window.

2) Impact resistance: a 25 mm steel ball was dropped from a height of 2 m at room temperature to check occurrence of cracks and damages in the reflection sheet. A reflector with no cracks and damages was evaluated as “Good”.

3) Productivity: Time required for fabrication and complexity of the fabrication process were compared.

4) Appearance: Cracks and peeling on the reflection sheet were checked. A reflector with no cracks and peeling was evaluated as “Good”.

TABLE 1

| | | | Comparative | Comparative |
|---|---|---|---|---|
| | Example 1 | Example 2 | Example 1 | Example 2 |
| Reflection | Good | Good | Good | Good |
| performance | | | | |
| Impact resistance | Good | Cracks | Cracks | Cracks |
| Productivity | Good | Good | Good | Poor |
| Appearance | Good | Good | Peels | Good |

Effect of the Invention

As described above, in the reflector of the present invention the fabrication time can be easily shortened even if a comparatively hard reflection sheet which can be elongated only with difficulty is used. In addition, the reflection sheet is effectively prevented from being cracked or peeling from the supporting body.

What is claimed is:

1. A reflector comprising: a supporting body which has a base having a surface extending in a longitudinal direction and a plurality of projections having a sloping surface sloping with respect to the surface of the base and being provided in the longitudinal direction of the surface of the base at regular intervals and bonded to the surface of the base, and a reflection sheet which has sections between the projections disposed between projections on the surface of the base and sloping sections adhering to the sloping surface of the projections;
wherein the length of the surface between the projections in the direction perpendicular to the longitudinal direction (direction of width) of the surface of the base is larger than the length of the projection in the same direction (direction of width), and the surface of the base has at least one peripheral surface of each projection extending along the periphery of the latitudinal direction of the projections at each of the projections so as to link the adjacent surfaces between projections;
and the reflection sheet further includes a peripheral section disposed on the peripheral surface of each projection to link the adjacent sections between the projections, and the sloping section of the reflection sheet is linked with one of the two adjacent sections between the projections and separated from the other section and the peripheral section of the projection.

2. The reflector according to claim 1, wherein the sloping section of the reflection sheet is formed by disposing the reflection sheet on a sloping surface of the projection so as to be separated and projected from the other section at notches provided to outline the plane configuration of the sloping section of the reflection sheet.

3. The reflector according to claim 2, wherein the sloping section of the reflection sheet has almost the same plane configuration as the plane configuration of the sloping surface of the projection.

4. The reflector according to claim 3, wherein the area of the sloping section of the reflection sheet is smaller than the area of the sloping surface of the projection so that the sloping surface of the projection is provided with a space not covered with the sloping part of the reflection sheet.

5. The reflector according to claim 1, wherein the base has a peripheral surface of each projection extending along the both peripheries of the projections in the latitudinal direction, the sloping section of the reflection sheet is is formed by disposing the reflection sheet on a sloping surface of the projection so as to be separated and projected from the other section at notches provided in the shape of the symbol “]” to outline the plane configuration of the sloping section of the reflection sheet, and the reflecting sheet has the peripheral section of each projection disposed on the peripheral surface of each projection.
